(19) United States
(12) Patent Application Publication
(10) Pub. No.: US 2008/0170974 A1
(43) Pub. Date: Jul. 17, 2008

(54) MICROWAVE SEWAGE TREATING APPARATUS

(75) Inventor: Jian Chen, Nanjing City (CN)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: Jinan Tai He Tian Run Environmental Technology Co., Ltd., Jinan City (CN)

(21) Appl. No.: 12/014,753

(22) Filed: Jan. 15, 2008

(30) Foreign Application Priority Data
Jan. 16, 2007 (CN) 200720033330.6

(51) Int. Cl. B01J 19/08

(52) U.S. Cl. 422/186

(57) ABSTRACT

A microwave sewage treating apparatus is disclosed. The apparatus comprises: a sewage source for supplying sewage; a microwave radiation system for irradiating the sewage with microwave, the microwave radiation system including a microwave generator for generating microwave, a microwave radiation chamber in which the sewage is irradiated with the microwave generated by the microwave generator, and a microwave radiation part for inputting the microwave generated by the microwave generator into the microwave radiation chamber; and a sewage pipe disposed in the microwave radiation chamber and having one end connected with the sewage source and the other end for outputting the sewage irradiated with the microwave. The microwave sewage treating apparatus according to the present disclosure is high in sewage treatment and low in operational cost and can treat various sewages. Indexes of water outputted by treating the sewage with the microwave sewage treating apparatus can completely reach discharge standards.

### RELATED APPLICATION

The present application claims the benefit of and priority to Chinese Patent Application No 200720033330.6 filed on Jan. 16, 2007, the contents of which are incorporated herein by reference in its entirety.

### BACKGROUND

1. Field

The present disclosure relates to a sewage treating apparatus, and particularly to a microwave sewage treating apparatus which is capable of treating sewage, such as municipal waste water, waste water generated by paper making, domestic sewage, with microwave.

2. Description of the Related Art

Technical literature “Special Microwave Oven for Fluid” discloses a treating apparatus for gas and liquid. The treating apparatus can only be used to heat liquid. The special industrial microwave oven is less efficient in sewage treatment efficiency and has high operation cost.

### SUMMARY

It is an object of the present disclosure to provide a microwave sewage treating apparatus which is capable of continuously treating sewage with microwave and outputting clean water.

In accordance with an aspect of the present disclosure, there is provided a microwave sewage treating apparatus comprising: a sewage source for supplying sewage; a microwave radiation system for irradiating the sewage with microwave, the microwave radiation system including a microwave generator for generating microwave, a microwave radiation chamber in which the sewage is irradiated with the microwave generated by the microwave generator, and a microwave radiation part for inputting the microwave generated by the microwave generator into the microwave radiation chamber; and a sewage pipe disposed in the microwave radiation chamber and having one end connected with the sewage source and the other end for outputting the sewage irradiated with the microwave.

In accordance with another aspect of the present disclosure, there is provided a microwave sewage treating apparatus comprising a dosing container for containing sewage, a microwave radiation system for irradiating the sewage with microwave, and a sedimentation tank. The dosing container is provided with a sewage inlet. The microwave radiation system includes a microwave radiation chamber as a closed chamber and a microwave generator. The microwave radiation chamber is provided with a microwave radiation part coupled with the microwave generator. A sewage reaction pipe or a sewage reaction pipe is disposed inside the microwave radiation chamber and has one end in fluid communication with the dosing container and the other end in fluid communication with the sedimentation tank. The sewage reaction pipe includes at least one circular portion.

In accordance with a further aspect of the present disclosure, the dosing container comprises 2-30 dosing containers according to actual requirements. Each of the dosing containers is a tank having a cubic capacity of 1 m³ to 20 m³. In use, the number of the dosing containers actually used can be determined depending upon requirements of sewage treatment.

In accordance with still another aspect of the present disclosure, in order to improve a sewage treatment capacity of the microwave radiation chamber and to facilitate usage and maintenance of the microwave sewage treating apparatus, the microwave generator is disposed on the ground, and the microwave radiation part may comprise a plurality of microwave radiation parts respectively disposed at different positions of the microwave radiation chamber. The microwave radiation part may comprise a first microwave radiation part Y disposed on a right side of the microwave radiation chamber, a second microwave radiation part M disposed on a left side of the microwave radiation chamber, and a third microwave radiation part W disposed on an upper side of the microwave radiation chamber. The microwave is radiated in a form of resonant antenna radiation in the first microwave radiation part Y. The microwave is radiated in a form of point multi-port radiation in the third microwave radiation part W. And the microwave is radiated in a form of resonator multimode electromagnetic radiation in the second microwave radiation part M.

The microwave may be radiated in a form of point type multi-port feed radiation in the third microwave radiation part W, and the microwave may be radiated in a form of resonant cavity multimode electromagnetic radiation in the second microwave radiation part M.

In accordance with another aspect of the present disclosure, the sewage to be treated is irradiated inside the microwave radiation chamber for 10 seconds to 10 minutes.

A filtering net for separating dirt from the sewage may be disposed in the sedimentation tank, and the sedimentation tank is used for separating and depositing the dirt.

With the configuration of the present disclosure, the sewage is continuously inputted into the microwave sewage treating apparatus so as to be heated and treated, and clean water is outputted.

In use, the sewage flows into the microwave radiation chamber so as to be treated with the microwave. In order to accelerate the radiation treatment, an additive can be used to accelerate reaction between molecules of the sewage and thus quickening sedimentation of suspended substance of the sewage.

The microwave generator may generate the microwave of a frequency of approximately 915 MHz or 2450 MHz.

The microwave sewage treating apparatus according to the present disclosure has high efficiency in sewage treatment efficiency and is of low operational cost. It is capable of treat various sewages. Indexes of water obtained by treating the sewage with the microwave sewage treating apparatus can completely reach discharge standards.

### BRIEF DESCRIPTION OF THE DRAWINGS

These and/or other aspects and advantages of the present disclosure will become apparent and more readily appreciated from the following description of the embodiments, taken in conjunction with the accompanying drawing.

FIG. 1 is a schematic view showing a microwave sewage treating apparatus according to the present disclosure.

### DETAILED DESCRIPTION OF THE EMBODIMENTS

The embodiments are described below in order to explain the present disclosure, but do not pose a limitation on the scope of the disclosure.

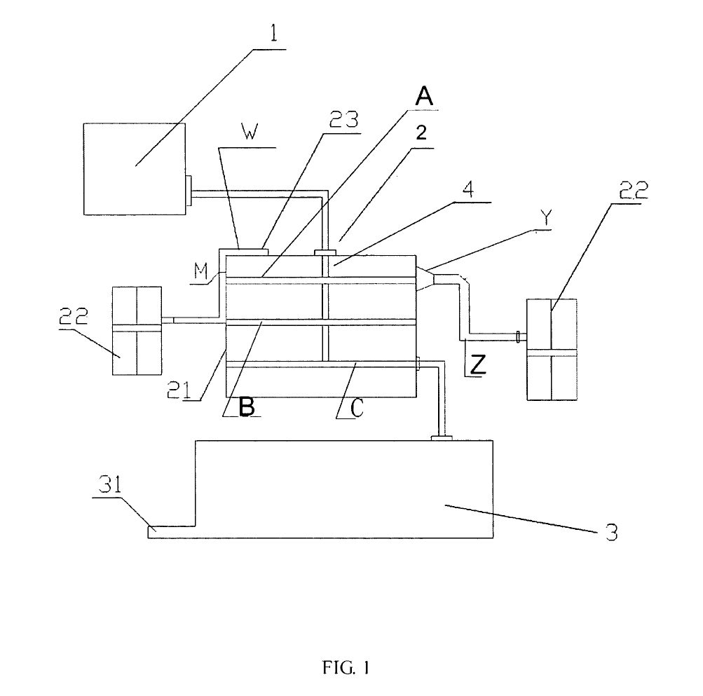

Referring to FIG. 1, a microwave sewage treating apparatus according to the present disclosure comprises: a sewage source for supplying sewage 1; and a microwave radiation system 2 for irradiating the sewage with microwave. The microwave radiation system includes a microwave generator 22 for generating microwave, a microwave radiation chamber 21 in which the sewage is irradiated with the microwave generated by the microwave generator 22, and a microwave radiation part 23 for inputting the microwave generated by the microwave generator 22 into the microwave radiation chamber 21. The microwave sewage treating apparatus further comprises a sewage pipe 4 disposed in the microwave radiation chamber 21 and having one end connected with the sewage source 1 and the other end for outputting the sewage irradiated with the microwave.

In an example shown in FIG. 1, the sewage source is a dosing container for containing the sewage. The microwave treating apparatus may further comprise a sedimentation tank 3. The sewage treated with the microwave and outputted from the sewage pipe is outputted into the sedimentation tank 3 so as to settle. The dosing container 1 is provided with a sewage inlet (not shown).

In the example shown in FIG. 1, the microwave radiation part 23 may comprise a first microwave radiation part Y disposed on a right side wall of the microwave radiation chamber 21, a second microwave radiation part M disposed on a left side wall of the microwave radiation chamber 21, and a third microwave radiation part W disposed on an top wall of the microwave radiation chamber 21. Alternatively, the first microwave radiation part Y and the second microwave radiation part M may be disposed at other positions on the side wall of the microwave chamber 21, while the third microwave radiation part W may be disposed at a bottom of the microwave chamber 21. In addition, the microwave sewage treating apparatus may comprise only one or two of the first microwave radiation part Y, the second microwave radiation part M, and the third microwave radiation part W, or more than three microwave radiation parts.

The microwave may be radiated in a form of resonant antenna radiation in the first microwave radiation part Y of the microwave radiation part 23. The microwave may be radiated in a form of point multi-port feed radiation in the third microwave radiation part W of the microwave radiation part 23. And the microwave may be radiated in a form of resonator multimode electromagnetic radiation in the second microwave radiation part M of the microwave radiation part 23.

In the example shown in FIG. 1, the microwave generator 22 may comprise two microwave generators 22, the right one of which being coupled with the first microwave radiation part Y through a waveguide Z, and the left one of which being coupled with the second microwave radiation part M and the third microwave radiation part W through a waveguide S. Alternatively, only one microwave generator 22 is provided to be coupled with the three microwave radiation parts, or three microwave generators 22 are provided to be coupled with the three microwave radiation parts, respectively. In addition, the microwave generators 22 may be disposed at any appropriate positions.

In the example shown in FIG. 1, the microwave radiation chamber 21 of the microwave radiation system 2 is a closed cavity. The sewage pipe 4 is disposed in the microwave radiation chamber 21. The sewage pipe 4 has one end in fluid communication with the dosing container 1 and the other end in fluid communication with the sedimentation tank 3. Specifically, the sewage pipe 4 comprises three substantially circular or annular sewage pipes A, B, and C. The sewage pipe A has one end connected with the dosing container 1 through a pipe, the sewage pipe C has one end connected with the sedimentation tank 3 through another pipe. The sewage pipe B has two ends respectively connected with the other ends of the sewage pipes A and C. The two ends of each of the sewage pipes A, B, and C are located adjacent and opposite to each other. The microwave radiation chamber 21 has a substantially circular cylindrical shape. The sewage pipes A, B and C extend along an inner wall of the microwave radiation chamber 21 so as to be in contact with the inner wall of the microwave radiation chamber 21 or to be spaced away from the inner wall of the microwave radiation chamber 21. Alternatively, the sewage pipe 4 may extend substantially spirally in the microwave radiation chamber 21.

The number of the dosing container 1 can be determined according to requirements of the sewage treatment. The dosing container generally comprises 2-30 dosing containers. Each of the dosing containers is a tank having a cubic capacity of 1 m³ to 20 m³.

The sewage to be treated may be irradiated inside the microwave radiation chamber 21 for 10 seconds to 10 minutes.

An operation of the microwave sewage treating apparatus according to the present disclosure as shown in FIG. 1 is described as follows.

For example, the sewage is pumped from a channel into the dosing container 1 located at a high position. An additive is selected to be mixed with the sewage depending upon properties of the sewage. The sewage mixed with the additive is inputted into the microwave radiation chamber 21 of the microwave radiation system 2. After it is detected that the sewage has flowed into the microwave radiation chamber 21, the microwave generator 22 is started. The microwave generator 22 outputs the microwave of a power depending upon yield of the microwave sewage treating apparatus. The microwave is guided by the waveguides or the wave guide tubes to the right side, the top, and the left side of the microwave radiation chamber 21, and is coupled into the microwave radiation chamber 21 through the microwave radiation parts fixed at the right side, the top, and the left side of the microwave radiation chamber 21 so as to decompose and treat the sewage flowing in the sewage pipe. The sewage is irradiated by the microwave from the right side, the top, and the left side. The microwave is an electromagnetic wave of a frequency of approximately 915 MHz. The sewage treated with the microwave flows into the sedimentation tank 3. After dirt is deposited and filtered from the sewage, clean water generated from the sewage is discharged into a tank located at a low position so as to flow into the channel again.

The microwave sewage treating apparatus according to the present disclosure may further comprise a controller (not shown) for controlling operation of the microwave sewage treating apparatus. Each of the two microwave generators may have a power of 20 kw or 10 km MHz.

1. A microwave sewage treating apparatus, comprising:
a sewage source for supplying sewage;
a microwave radiation system for irradiating the sewage with microwave, the microwave radiation system including a microwave generator for generating microwave, a microwave radiation chamber in which the sewage is irradiated with the microwave generated by the microwave generator, and a microwave radiation part for inputting the microwave generated by the microwave generator into the microwave radiation chamber; and
a sewage pipe disposed in the microwave radiation chamber and having one end connected with the sewage source and the other end for outputting the sewage irradiated with the microwave.

2. The microwave sewage treating apparatus according to claim 1, wherein the sewage source comprises a dosing container for containing the sewage.

3. The microwave sewage treating apparatus according to claim 1, wherein the microwave radiation part comprises a first microwave radiation part disposed on a first side of the microwave radiation chamber, a second microwave radiation part disposed on a second side of the microwave radiation chamber, and a third microwave radiation part disposed on an top of the microwave radiation chamber.

4. The microwave sewage treating apparatus according to claim 3, wherein the first side and the second side of the microwave radiation chamber are configured to be opposite to each other.

5. The microwave sewage treating apparatus according to claim 4, wherein the microwave is radiated in a form of resonant antenna radiation in the first microwave radiation part of the microwave radiation part, the microwave is radiated in a form of point multi-port radiation in the third microwave radiation part of the microwave radiation part, and the microwave is radiated in a form of resonant cavity multimode electromagnetic radiation in the second microwave radiation part of the microwave radiation part.

6. The microwave sewage treating apparatus according to claim 5, wherein the microwave generator comprises two microwave generators, one of which being coupled with the first microwave radiation part through a waveguide, and the other of which being coupled with the second microwave radiation part and the third microwave radiation part through another waveguide.

7. The microwave sewage treating apparatus according to claim 6, wherein the sewage pipe extends substantially spirally in the microwave radiation chamber.

8. The microwave sewage treating apparatus according to claim 7, wherein the microwave radiation chamber has a substantially circular cylindrical shape and the sewage pipe extends along an inner wall of the microwave radiation chamber.

9. The microwave sewage treating apparatus according to claim 8, further comprising:
a sedimentation tank to which the other end of the sewage pipe is connected.

10. The microwave sewage treating apparatus according to claim 9, wherein the dosing container comprises 2-30 dosing containers and each of the dosing containers is a tank having a cubic capacity of 1 m³ to 20 m³.

11. The microwave sewage treating apparatus according to claim 6, wherein the sewage pipe comprises a plurality of substantially circular or annular sewage pipes connected with one another and arranged in a vertical direction of the microwave radiation chamber.

12. The microwave sewage treating apparatus according to claim 1, wherein the sewage to be treated is irradiated inside the microwave radiation chamber for 10 seconds to 10 minutes.

13. The microwave sewage treating apparatus according to claim 1, further comprising a filtering net disposed in the sedimentation tank for separating dirt from the sewage.

14. The microwave sewage treating apparatus according to claim 1, wherein the microwave generated by the microwave generator has a frequency of approximately 915 MHz or 2450 MHz.

15. The microwave sewage treating apparatus according to claim 6, wherein each of the two microwave generator has a power of 20 kw or 10 kmM Hz.
